(19) United States
(12) Patent Application Publication
(10) Pub. No.: US 2008/0256800 A1
(43) Pub. Date: Oct. 23, 2008

(54) Razor cartridge assembly with movable face

(76) Inventor: Roy Nicoll, Winnersh (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/788,537

(22) Filed: Apr. 20, 2007

(51) Int. Cl. B26B 21/22

(52) U.S. Cl. 30/50; 30/32

(57) ABSTRACT

A razor cartridge including a blade unit and a frame directly joined to the blade unit. The blade unit includes a plurality of shaving blades secured to the blade unit. The blade unit has an upper face and a lower face. The frame has an upper member and a lower member. The upper member is movable between a first position and a second position. The upper face of the upper member forms a substantially contiguous extension of the upper face of the blade unit when in the second position.

### FIELD OF THE INVENTION

The present invention relates to a razor cartridge assembly for a wet-shave type razor and more particularly to a razor cartridge having a frame joined to a blade unit where the frame has a movable face.

### BACKGROUND OF THE INVENTION

It is known in the prior art to provide a razor cartridge assembly having a frame secured to a blade unit. The prior art assemblies are of such a design that the blade unit is secured to the frame such that the blade unit resides on top of the frame. The result is that the upper face or skin contacting surfaces of the blade unit and frame reside in very different planes. Said another way, the upper face of the frame does not form a contiguous extension of the upper face of the blade unit. This results in a very uneven shaving surface.

It would be beneficial to provide a razor cartridge assembly having a frame joined to a blade unit such that the upper face of the frame forms a substantially contiguous extension of the upper face of the blade unit when a force is applied to the upper face of the frame such as during a shaving stroke. Having the upper face of the frame forming a substantially contiguous extension of the upper face of the blade unit during a shaving stroke provides an improved even shaving surface.

### SUMMARY OF THE INVENTION

In accordance with the present invention a razor cartridge is provided. The razor cartridge comprises a frame directly joined to a blade unit. The blade unit comprises a plurality of shaving blades secured to the blade unit. The blade unit comprises an upper face and a lower face. The frame comprises a lower member and an upper member secured to the lower member. The lower member of the frame is directly joined to the blade unit. The upper member has an upper face, a lower face and an opening extending from the upper face to the lower face. The upper member is positioned relative to the blade unit such that the upper member is movable between a first position and a second position. In the first position the upper face of the upper member is higher than the upper face of the blade unit and in the second position the upper face of the upper member is equal to the upper face of the blade unit. The frame is joined to the blade unit such that the upper face of the upper member forms a substantially contiguous extension of the upper face of the blade unit when in the second position. The upper member moves to the second position when a sufficient force is applied to the upper face of the upper member. An example of a sufficient force is the force applied to the upper member during a shaving stroke.

In accordance with an aspect of the present invention the blades are secured to the blade unit with a pair of clips.

In accordance with another aspect of the present invention the lower member of the frame is joined to the blade unit with a latch structure. The latch structure may include a plurality of recesses and a plurality of protrusions. The protrusions are designed to engage with the recesses.

In accordance with another aspect of the present invention the blade unit comprises at least 3 blades. In another aspect of the present invention the blade unit comprises at least 5 blades.

In accordance with another aspect of the present invention the upper face of the blade unit comprises a guard and a cap.

In accordance with another aspect of the present invention the upper face of the upper member of the frame comprises a guard and a cap. The guard on the frame may comprise an elastomeric member. The cap on the frame may comprise a lubrication member.

In accordance with another aspect of the present invention the upper face of the upper member of the frame comprises a lubrication member completely surrounding the upper member and the blade unit.

A plurality of force absorbing members are positioned between the upper member and the lower member. The force absorbing members may be selected from the group consisting of springs, elastomeric members, and rubber members. The force absorbing members serve to absorb the force applied to the upper member allowing the upper member to move from the first position to the second position. The force absorbing members may also serve to join the upper member to the lower member.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 is a perspective view of a razor cartridge of the present invention with the upper member in the first position.

FIG. 2 is a perspective view of the frame of FIG. 1.

FIG. 3 is a perspective view of the blade unit of FIG. 1.

FIG. 4 is a perspective view of the lower member of the frame of FIG. 1.

FIG. 5 is a perspective view of the razor cartridge of FIG. 1 with the upper member in the second position.

FIG. 6 is a perspective view of another razor cartridge of the present invention with the upper member in the first position.

FIG. 7 is a perspective view of the razor cartridge of FIG. 6 with the upper member in the second position.

### DETAILED DESCRIPTION OF THE INVENTION

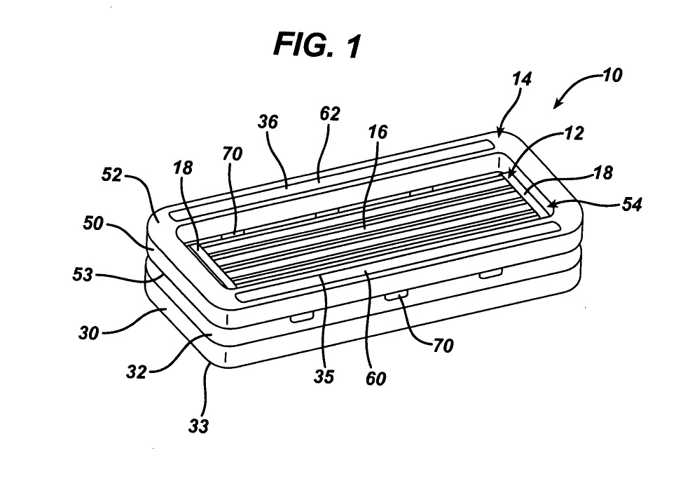

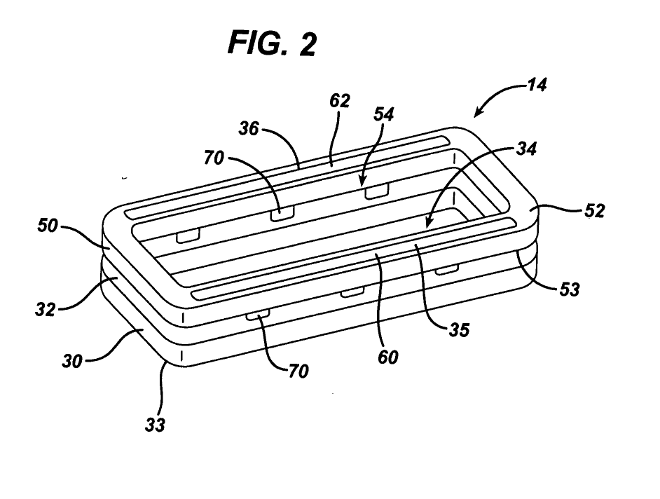

Referring now to FIGS. 1-5 there is shown a razor cartridge 10 of the present invention. The razor cartridge 10 comprises a blade unit 12 joined to a frame 14.

A plurality of shaving blades 16 are secured to blade unit 12. The shaving blades 16 are secured to blade unit 12 with a pair of clips 18. Clips 18 are positioned at opposite ends of blade unit 12. While clips 18 are used to secure shaving blades 16 to blade unit 12 in the embodiment shown, other methods may be used to secure shaving blades 16 to blade unit 12. Blade unit 12 has an upper face 28 and a lower face 29.

Blade unit 12 is shown to have three shaving blades 16. The blade unit 12 may include more than three shaving blades 16. For example, the blade unit 12 may comprise at least three, at least four, at least five, at least six or more shaving blades 16.

Frame 14 comprises a first lower member 30 and a second upper member 50 secured to first lower member 30. Lower member 30 comprises an upper face 32, a lower face 33 and an opening 34 extending from upper face 32 to lower face 33. Opening 34 is sized and shaped for receiving blade unit 12. Lower member 30 of frame 14 is directly joined to blade unit 12.

Upper member 50 comprises an upper face 52, a lower face 53 and an opening 54 extending from upper face 52 to lower face 53. The opening 54 in upper member 50 is sized and shaped to allow upper member 50 to move in an up and down motion with respect to blade unit 12.

Blade unit 12 comprises a pair of opposing side walls 20 and a pair of opposing end walls 22. Lower member 30 of frame 14 comprises a pair of opposing side walls 40 and a pair of opposing end walls 42.

Lower member 30 of frame 14 is secured to the blade unit 12 with a latch structure 43. The latch structure 43 comprises a plurality of recesses 44 and a plurality of protrusions 45 located on side walls 20 of blade unit 12. The latch structure 43 also comprises a plurality of recesses 46 and a plurality of protrusions 47 located on side walls 40 of lower member 30. Protrusions 45 engage with recesses 46 and protrusions 47 engage with recesses 44 to join lower member 30 of frame 14 directly to blade unit 12.

While latch structure 43 is used to join lower member 30 of frame 14 to blade unit 12 in the embodiment shown, other methods may be used to join lower member 30 to blade unit 12. Other methods include but are not limited to heat staking pins, adhesives, clips, etc.

A plurality of force absorbing members 70 are positioned between the lower member 30 and the upper member 50. The force absorbing members 70 may serve to secure the lower member 30 to the upper member 50. The force absorbing members 70 serve to absorb an applied force such as during a shave stroke. As they absorb the applied force, the force absorbing member 70 compress. As the force absorbing members 70 compress, the upper face 52 of the upper member 50 moves from a first position to a second position. In the first position, the upper face 52 of upper member 50 is higher than the upper face 28 of the blade unit 12. In the second position, the upper face 52 of the upper member 50 is substantially equal to the upper face 28 of the blade unit 12 such that the upper face 52 of the upper member 50 forms a substantially contiguous extension of the upper face 28 of the blade unit 12.

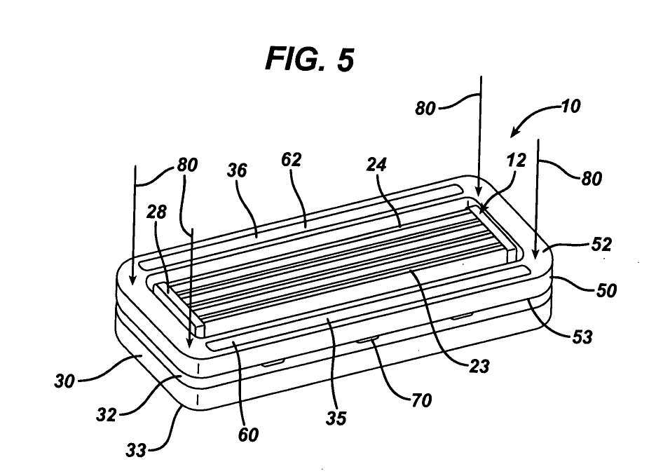

In FIG. 1, the upper member 50 is in a first position such that the upper face 52 is higher than the upper face 28 of the blade unit 12. In FIG. 5, a force 80 is applied to the upper face 52 of upper member 50 compressing the force absorbing members 70. In this situation the force applied is the force of a shaving stroke as the razor cartridge glides across the user's skin. In the second position, the upper face 52 is at a substantially equal height to that of the upper face 28 of the blade unit 12 such that the upper face 52 forms a substantially contiguous extension of the upper face 28 of blade unit 12. In the second position, both the upper face 28 of blade unit 12 and the upper face 52 of upper member 50 will be in direct contact with the user's skin during the shaving stroke. This uniform skin contacting surface provides an even shaving surface. The upper face 52 of the upper member 50 need not be an exact contiguous extension of the upper face 28 of the blade unit 12 while in the second position such that minor differences are acceptable. However, the differences must not be so great that hey lead to an inferior shave.

The upper face 28 of blade unit 12 comprises a guard 23 and a cap 24. The upper face 52 of upper member 50 comprises a guard 35 and a cap 36. Guards 23 and 35 are positioned in front of shaving blades 16 such that they contact the user's skin before shaving blades 16. Caps 24 and 36 are positioned behind shaving blades 16 such that they contact the user's skin after shaving blades 16. Guard 23 is substantially contiguous with guard 35 when upper member 50 is in the second position. Cap 24 is substantially contiguous with cap 36 when upper member 50 is in the second position.

The guard 35 on upper member 50 comprises an elastomeric member 60. Numerous structures are known for use as an elastomeric member. The cap 36 on upper member 50 comprises a lubrication member 62. Numerous structures are known for use as a lubrication member.

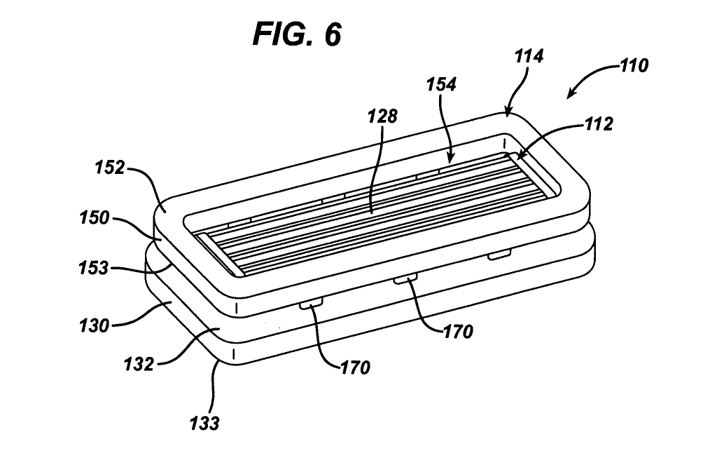

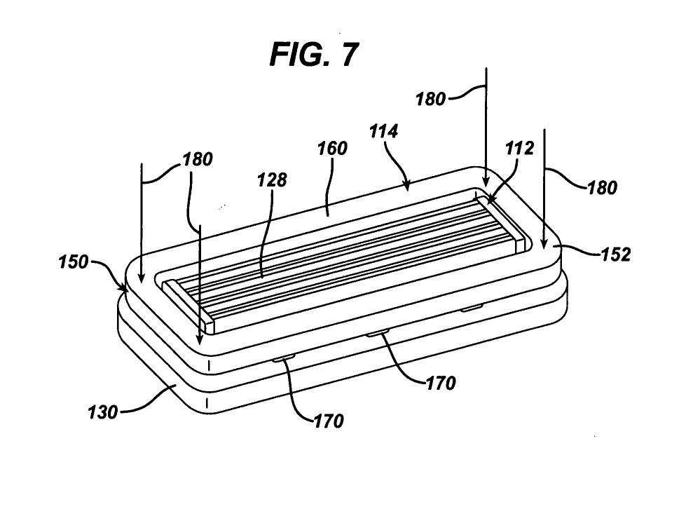

Referring now to FIGS. 6-7 there is shown another razor cartridge 110 of the present invention. The razor cartridge 110 comprises a blade unit 112 joined to a frame 114.

Blade unit 112 is similar to blade unit 12 shown in FIGS. 1, 3 and 5.

Frame 114 comprises a first lower member 130 and a second upper member 150 secured to the first lower member 130. Lower member 130 is similar to lower member 30 shown in FIGS. 1, 2, 4 and 5 comprising an upper face 132, a lower face 133 and an opening (not shown) extending from upper face 132 to lower face 133. Lower member 130 is directly joined to blade unit 112.

Upper member 150 comprises an upper face 152, a lower face 153 and an opening 154 extending from upper face 152 to lower face 153. The opening 154 in upper member 150 is sized and shaped to allow upper member 150 to move in an up and down motion with respect to blade unit 112.

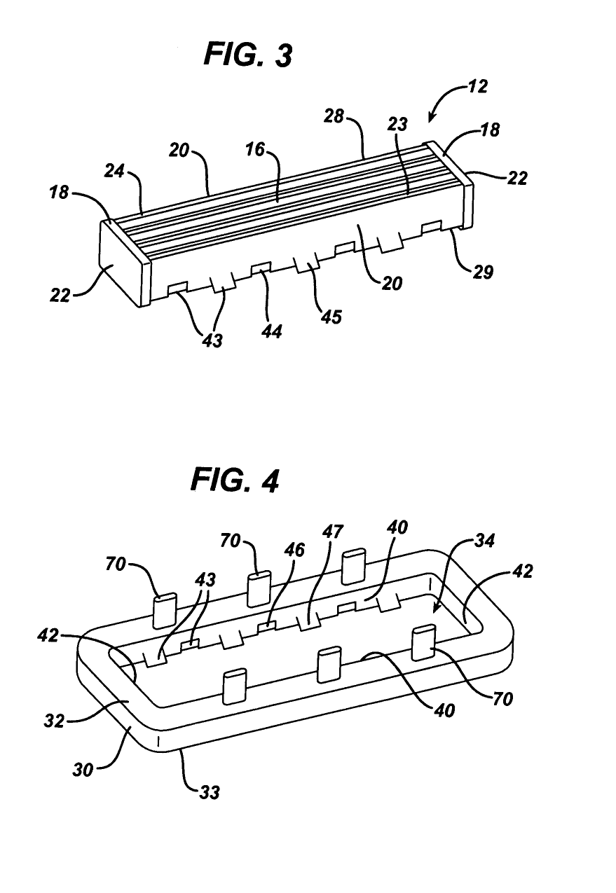

Lower member 130 of frame 114 is directly joined to the blade unit 112 with a latch structure similar to latch structure 43, shown in FIGS. 3 and 4.

A plurality of force absorbing members 170 extend between the lower member 130 and the upper member 150. The force absorbing members 170 may serve to secure the lower member 130 to the upper member 150. The force absorbing members 170 serve to absorb an applied force such as during a shave stroke. As they absorb the applied force, the force absorbing member 170 compress. As the force absorbing members 170 compress, the upper face 152 of the upper member 150 moves from a first position to a second position. In the first position, the upper face 152 of upper member 150 is higher than the upper face 128 of the blade unit 112. In the second position, the upper face 152 of the upper member 150 is substantially equal to the upper face 128 of the blade unit 112 such that the upper face 152 of the upper member 150 forms a substantially contiguous extension of the upper face 128 of the blade unit 112.

In FIG. 6, the upper member 150 is in a first position such that the upper face 152 is higher than the upper face 128 of the blade unit 112. In FIG. 7, a force 180 is applied to the upper face 152 of upper member 150 compressing the force absorbing members 170. In this situation the force applied is the force of a shaving stroke as the razor cartridge glides across the user's skin. In the second position, the upper face 152 is at a substantially equal height to that of the upper face 128 of the blade unit 112 such that the upper face 152 forms a substantially contiguous extension of the upper face 128 of blade unit 112. In the second position, both the upper face 128 of blade unit 112 and the upper face 152 of upper member 150 will be in direct contact with the user's skin during the shaving stroke. This uniform skin contacting surface provides an even shaving surface. The upper face 152 of the upper member 150 need not be an exact contiguous extension of the upper face 128 of the blade unit 112 while in the second position such that minor differences are acceptable. However, the differences must not be so great that hey lead to an inferior shave.

The upper face 152 of upper member 150 comprises a lubrication member 160 that completely surrounds upper member 150 and blade unit 112. Alternatively, the entire upper member 150 may be comprised of a lubrication material such that upper member 150 is a lubrication member completely surrounding blade unit 112.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm“.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising:
a blade unit comprising a plurality of shaving blades secured to said blade unit, said blade unit having an upper face and a lower face;
a frame comprising a lower member and an upper member secured to said lower member, said lower member being directly joined to said blade unit, said upper member having an upper face, a lower face and an opening extending from said upper face to said lower face, said upper member being movable between a first position and a second position, in said first position said upper face of said upper member being higher than said upper face of said blade unit and in said second position said upper face of said upper member forming a substantially contiguous extension of said upper face of said blade unit.

2. The razor cartridge of claim 1 wherein said blades are secured to said blade unit with a pair of clips.

3. The razor cartridge of claim 1 wherein said lower member is joined to said blade unit with a latch structure.

4. The razor cartridge of claim 3 wherein said latch structure includes a plurality of recesses and a plurality of protrusions.

5. The razor cartridge of claim 4 wherein said protrusions engage with said recesses.

6. The razor cartridge of claim 1 wherein said blade unit comprises at least 3 blades.

7. The razor cartridge of claim 1 wherein said blade unit comprises at least 5 blades.

8. The razor cartridge of claim 1 wherein said upper face of said blade unit further comprises a guard and a cap.

9. The razor cartridge of claim 1 wherein said upper face of said upper member further comprises a guard and a cap.

10. The razor cartridge of claim 9 wherein said guard on said upper member further comprises an elastomeric member.

11. The razor cartridge of claim 9 wherein said cap on said upper member further comprises a lubrication member.

12. The razor cartridge of claim 1 wherein said upper face of said upper member further comprises a lubrication member completely surrounding said blade unit.

13. The razor cartridge of claim 1 wherein said frame further comprises a plurality of force absorbing members positioned between the upper member and the lower member.

14. The razor cartridge of claim 13 wherein said force absorbing members are selected from the group consisting of springs, elastomeric members and rubber members.

15. The razor cartridge of claim 1 wherein said upper member moves to said second position when a sufficient force is applied to the upper face of the upper member.

16. A razor cartridge comprising:
a blade unit comprising a plurality of shaving blades secured to said blade unit, said blade unit having an upper face and a lower face;
a frame comprising a lower member and an upper member secured to said lower member, said lower member being directly joined to said blade unit, said upper member having an upper face, a lower face and an opening extending from said upper face to said lower face, said upper member being movable between a first position and a second position, in said first position said upper face of said upper member being higher than said upper face of said blade unit and in said second position said upper face of said upper member being substantially equal to said upper face of said blade unit forming a substantially contiguous extension of said upper face of said blade unit.

17. The razor cartridge of claim 16 wherein said blades are secured to said blade unit with a pair of clips.

18. The razor cartridge of claim 16 wherein said lower member is joined to said blade unit with a latch structure.

19. The razor cartridge of claim 18 wherein said latch structure includes a plurality of recesses and a plurality of protrusions.
